(19) United States
(12) Patent Application Publication
(10) Pub. No.: US 2009/0177293 A1
(43) Pub. Date: Jul. 9, 2009

(54) Method for negotiating a purchase price for goods

(76) Inventors: Steven Bruce Reginald, Chillicothe, IL (US); William James Lindholm, Peoria, IL (US); Jeffrey Charles Anderson, Bartonville, IL (US); Jonathan David Roe, Derby (GB); Brent Bannister Sugden, Argenta, IL (US)

Correspondence Address: CATERPILLAR/FINNEGAN, HENDERSON, L.L.P., 901 New York Avenue, NW, WASHINGTON, DC, 20001-4413, US

(21) Appl. No.: 12/007,102

(22) Filed: Jan. 7, 2008

(51) Int. Cl. G05B 13/02; G06Q 10/00; G06F 3/048; G06Q 30/00

(52) U.S. Cl. 700/36; 705/80; 705/400; 715/764

(57) ABSTRACT

A method for negotiating a purchase price for an assembled good to be delivered to a purchaser is disclosed. In one embodiment, the method includes storing a value representing an estimated number of assembled goods desired for delivery in a particular time period, and using a computer program to estimate an optimal number of setups per the time period and an optimal order quantity per setup, based on the value and other stored information, and based on automatic calculations by the computer program. The method further includes automatically estimating an optimal should-cost purchase price for the assembled good based on the value, the estimated optimal number of setups, and the estimated optimal order quantity, and using the estimated optimal should-cost purchase price to negotiate a final purchase price for the assembled good.

### TECHNICAL FIELD

The present disclosure relates generally to negotiation mechanisms, and more particularly to methods and systems for facilitating negotiations between sellers and purchasers of an assembled good.

### BACKGROUND

Companies typically use should-cost information to determine a selling price for assembled goods. “Should-cost” information refers to information that indicates what an item should cost to a potential purchaser or to a manufacturer or seller. For example, should-cost information for an assembled good may include information indicating estimated costs for material and/or parts of the assembled good, information indicating estimated costs of the processes for assembling the parts into the assembled good, information indicating estimated costs of processes to alter any parts used to assemble the good, etc. Often, should-cost information is used individually by a purchaser of an assembled good or a seller of an assembled good to determine, for example, a price the purchaser should offer to pay for the good, or a price at which the seller should offer to sell the good.

In some cases, should-cost information is used to negotiate the price for an assembled good. Software files, such as spreadsheets, have been developed that permit purchasers and sellers to enter data related to should-cost information in order to arrive at a should-cost price estimate for the assembled good. One example of such a spreadsheet is the “Should Cost Worksheet V2.51,” implemented Jun. 9, 2005, and used by Caterpillar Inc.® (hereinafter “V2.51”). This worksheet is used to negotiate prices for goods with suppliers. The worksheet may be loaded by a purchaser with should-cost data from a database, and may be used to calculate a should-cost price for an assembled good. In addition, a blank worksheet may be given to suppliers, who may manually (using software such as Microsoft Excel™) fill in portions of the worksheet to estimate their should-cost price for parts, materials, and certain processes used to manufacture the assembled good. The supplier and purchaser may then negotiate a sale price based on the information stored in their respective should-cost spreadsheets. A further example of such a spreadsheet is the “Should Cost Worksheet V3.24,” implemented on Jun. 16, 2006, and used by Caterpillar Inc.® (hereinafter “V3.24”).

While existing should-cost mechanisms are useful in negotiation settings, these mechanisms could benefit from improvements that provide for the determination of optimal should-cost values, and thus for more accurate and reliable estimates and comparisons of should-cost values. For instance, although V2.51 and V3.24 permit a user to adjust certain should-cost information, they do not provide a tool for automatically determining certain optimal values that affect the overall should-cost price. For example, neither V2.51 nor V3.24 automatically determine an optimal number of manufacturing setups per year, an optimal order quantity of assembled goods per setup, or an optimal should-cost purchase price. Thus, neither V2.51 nor V3.24 provide a tool for both a purchaser and seller to determine an optimal manufacturing plan that minimizes manufacturing and inventory costs. V2.51 and V3.24 further fail to provide a tool for automatically comparing optimal information related to two separate assembled goods in a single, easily viewable interface.

Consequently, existing should-cost mechanisms stand to be improved with a more efficient, reliable, and accurate should-cost model that helps determine optimal should-cost values.

The disclosed embodiments are directed to overcoming one or more of the problems set forth above.

### SUMMARY OF THE INVENTION

In one embodiment, a method for negotiating a purchase price for an assembled good to be delivered to a purchaser is disclosed. The method includes storing a value representing an estimated number of assembled goods desired for delivery in a particular time period, and using a computer program to estimate an optimal number of setups per the time period and an optimal order quantity per setup, based on the value and other stored information, and based on automatic calculations by the computer program. The method further includes automatically estimating an optimal should-cost purchase price for the assembled good based on the value, the estimated optimal number of setups, and the estimated optimal order quantity, and using the estimated optimal should-cost purchase price to negotiate a final purchase price for the assembled good.

In another embodiment, a method of providing an estimated optimal should-cost purchase price for an assembled good to be delivered to a purchaser is disclosed. The method includes storing a value representing an estimated number of assembled goods desired for delivery in a particular time period, and estimating, using a computer program tool that is part of a computer program, and based at least on the value, an optimal number of setups per the particular time period and an optimal order quantity per setup for the assembled good. The method further includes automatically inputting data into a data structure that is part of the computer program. The data may include the estimated optimal order quantity and the estimated optimal number of setups. In one embodiment, the computer program is used to estimate, based on one or more stored equations, an optimal should-cost purchase price for the assembled good. The estimated optimal should-cost purchase price may be provided to a user of the computer program tool.

In a further embodiment, a computer program product is disclosed. The computer program product may be stored on a computer-readable medium. In one embodiment, the computer program product includes instructions configured to cause one or more processors to receive a value representing a number of assembled goods desired for delivery in a particular time period, and estimate an optimal number of setups per the time period and an optimal order quantity per setup, based on the value and other stored information, and based on automatic calculations. The computer program product may further include instructions configured to cause the one or more processors to automatically estimate an optimal should-cost purchase price for the assembled goods based on the value, the estimated optimal number of setups, and the estimated optimal order quantity, and to cause the estimated optimal should-cost purchase price to be displayed on a display screen, to be used to negotiate a final purchase price for the assembled goods.

### BRIEF DESCRIPTION OF THE DRAWINGS

FIG. 1 is a is a block diagram illustrating an exemplary system consistent with certain disclosed embodiments;

FIG. 2 is a block diagram of an exemplary purchaser computer system consistent with certain disclosed embodiments;

FIG. 3a is a diagram of a first portion of an exemplary populated data file consistent with certain disclosed embodiments;

FIG. 3b is a diagram of a second portion of an exemplary populated data file consistent with certain disclosed embodiments;

FIG. 4a is a diagram of a first portion of an exemplary blank data file consistent with certain disclosed embodiments;

FIG. 4b is a diagram of a second portion of an exemplary blank data file consistent with certain disclosed embodiments;

FIG. 5 is a diagram of an exemplary bar chart reflecting operation costs consistent with certain disclosed embodiments;

FIG. 6 is a flow chart illustrating an exemplary method consistent with certain disclosed embodiments;

FIG. 7 is a diagram of a computer program tool consistent with certain disclosed embodiments; and

FIG. 8 is a diagram of an exemplary computer program tool consistent with certain disclosed embodiments.

### DETAILED DESCRIPTION

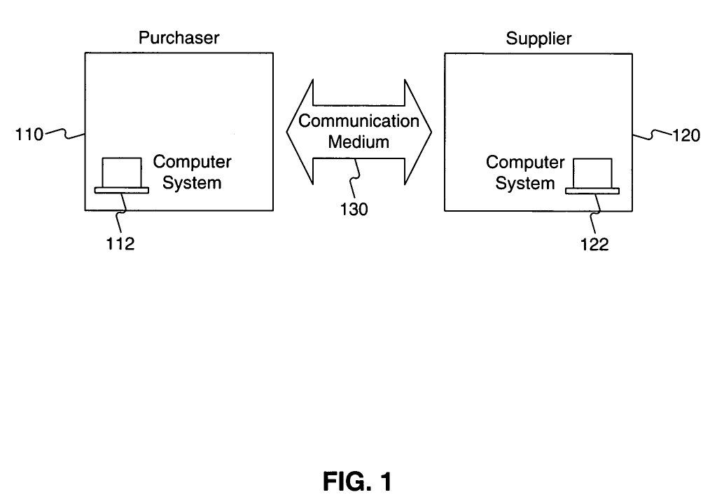

FIG. 1 depicts an exemplary system 100 consistent with certain disclosed embodiments. System 100 includes purchaser 10 and associated purchaser computer system 112, supplier 120 and associated supplier computer system 122, and communication medium 130.

Purchaser 10 may be a company, individual, governmental agency, corporation, non-profit organization, or other entity that purchases assembled goods from suppliers. The term “assembled good” refers to any item that is formed through an assembly process (e.g., created from one or more parts, altered into a new form, etc.) and that may be sold to a purchaser. For example, in one embodiment, purchaser may be a machine manufacturer who purchases machine parts from suppliers. In one embodiment, the machine parts are assembled goods (e.g., goods made by combining machine part components) manufactured by a supplier.

Purchaser computer system 112 may be a personal computer (PC), workstation, laptop computer, personal digital assistant (PDA) or other hand-held device, or any other data processing system capable of carrying out one or more of the disclosed embodiments. In one embodiment, purchaser computer system 112 may be a combination of PCs, workstations, laptop computers, PDAs, and the like, connected by a communication network (e.g., the Internet). For example, in one embodiment, computer system 112 is a PC connected via a network to a central server that stores part information in a database. The PC may additionally be connected to the Internet or another network. Although described as separate elements, a “purchaser,” as used herein, may refer to a purchaser computer system or an individual, company, agency, corporation, organization, etc.

Supplier 120 may be a company, individual, governmental agency, corporation, non-profit organization, or other entity that sells goods to purchasers. For example, in one embodiment, supplier 120 is a machine part manufacturer who sells machine parts to a machine manufacturer. Supplier 120 need not be a manufacturer, however, and may be, for example, a re-seller or distributor of manufactured goods. The term “supplier” may also be referred to as “seller.” Supplier computer system 122 may be a personal computer (PC), workstation, laptop computer, PDA or other hand-held device, or any other data processing system capable of carrying out one or more of the disclosed embodiments. In one embodiment, supplier computer system 122 may be a combination of PCs, workstations, laptop computers, PDAs, and the like, connected by a communication network (e.g., the Internet). For example, in one embodiment, supplier computer system 122 is a PC connected via a network to a central server that stores part information in a database. The PC may additionally be connected to the Internet or another network. Although described as separate elements, a “supplier” or “seller,” as used herein, may refer to a supplier or seller computer system, or to an individual, company, agency, corporation, organization, etc.

Communication medium 130 is any communication medium or combination of communication media that provides a forum for purchaser 110 and supplier 120 to communicate and negotiate with each other. Communication medium 130 may be a telephone network, postal mail network, computer network, fax network, wireless communication network, combination of one or more of these networks, or other medium that permits the exchange of information by paper, electronic, audio, or other means. In one embodiment, communication medium 130 may be a physical location (e.g., meeting room) where purchaser 110 and supplier 120 meet and exchange information. In other embodiments, communication medium 130 is a data communication network for exchanging data between remote systems. As described further below, system 100 allows purchasers and suppliers to negotiate the sale (i.e., purchase) of a good by permitting both a purchaser and a supplier to determine a “should-cost” purchase price for the good and its parts and by permitting the purchaser and supplier to exchange their should-cost prices (e.g., by exchanging data in the form of a spreadsheet or table). System 100 also allows purchasers to determine, negotiate, exchange information relating to an optimal manufacturing plan, and to estimate an optimal should-cost purchase price based on that plan. Thus, communication medium 130 may be any medium that permits such communication.

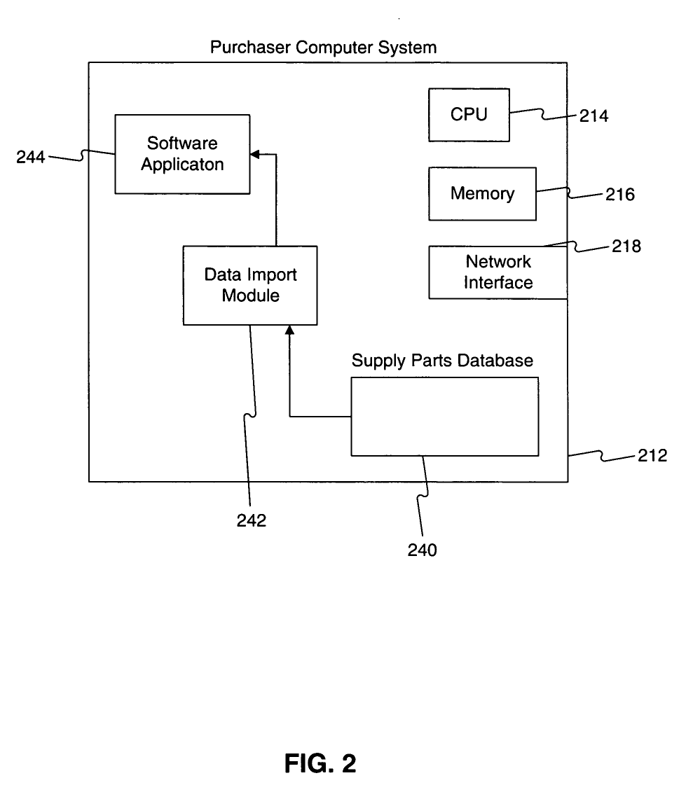

FIG. 2 depicts an exemplary computer system 212 associated with a purchaser, consistent with out one or more disclosed embodiments. As described above, purchaser computer system 212 may be one or more PCs, laptop computers, PDAs, workstations, etc., either standing alone or combined as part of a communication network. In one embodiment, computer system 212 includes hardware components, such as central processing unit (CPU) 214, memory storage 216, network interface 218, and any other known components (e.g., CD/DVD ROM drive, I/O ports, power source, display screen, keyboard, mouse, etc.) typically used in data processing devices such as PCs, PDAs, laptops, etc. Computer system 212 additionally includes one or more software or firmware components (e.g., applications, macros, computer program code such as Visual Basic™, C++, and/or other computer programs) stored on a computer readable medium (e.g., hard drive, ROM memory, RAM memory, flash memory, etc.) and used to operate computer system 212. In one embodiment, computer system 212 uses these hardware, software, and/or firmware components to implement supply parts database 240, data import module 242, and software application 244. In one embodiment, supplier computer system 122 may be configured similarly to purchaser computer system 212.

Supply parts database 240 is a database or other storage device that stores information relating to parts used by supplier 120 to manufacture assembled goods. In one embodiment, for each part, supply parts database 240 stores information that describes the part, describes one or more processes that may be necessary to alter the part for use in one or more assembled goods, and describes other characteristics related to the part. For example, in one embodiment, the information includes a part identifier, such as a name (e.g., valve, flange, bolt, washer, hose, seal, etc.), part number, part material(s) (e.g., steel, rubber, plastic, etc.), part weight (in lbs. or kgs.), part cost, part operations that may be necessary for each part when including the part in the assembled good (e.g., sawing, machine-cutting, laser cutting, welding, painting packing and shipping, inspection, etc.), costs and/or cost rates of those operations, number of parts required for each assembled good, taxes or additional fees associated with the part, other miscellaneous costs, etc. In one embodiment, supply parts database 240 may be stored, for example, in a database accessible by a software application such as Costimator™, offered by MTI Systems Inc. Database 240 may be stored locally on purchaser computer system 212 (e.g., stored on a PC if computer system 212 is a PC), may be stored remotely (e.g., stored on a remote server if computer system 212 is a PC), or may be stored in a distributed manner (e.g., stored on multiple computers, such as, e.g., a PC and a remote server).

In one embodiment, one or more sets of data stored in parts database 240 may be selected, extracted, and stored as files. For example, using Costimator or a similar software application, a user may make a selection instructing the software application to extract all data related to manufacturing a particular assembled good (e.g., a fuel tank, transmission, drive train, etc.). In response to the selection, the software application may create a text file (e.g., .txt, .csv), a spreadsheet file (e.g., .xls), or other type of computer-usable data file that stores the extracted data. The file is configured to be accessed by data import module 242. In another embodiment, one or more sets of data stored in parts database 240 may be additionally or alternatively accessed directly from parts database 240 by data import module 242.

Data sets stored as files or stored in parts database 240 may then be accessed by data import module 242 to populate a file (e.g., spreadsheet or other type of displayable worksheet file) to be displayed by software application 244. Data import module 242 includes program code that instructs a processor, such as CPU 214, to import data from a stored data file or from supply parts database 240 to software application 244. Data import module 242 may be written using macros or other programming tools, and may be written in any suitable programming language, such as Visual Basic™, Java™, C++, etc.

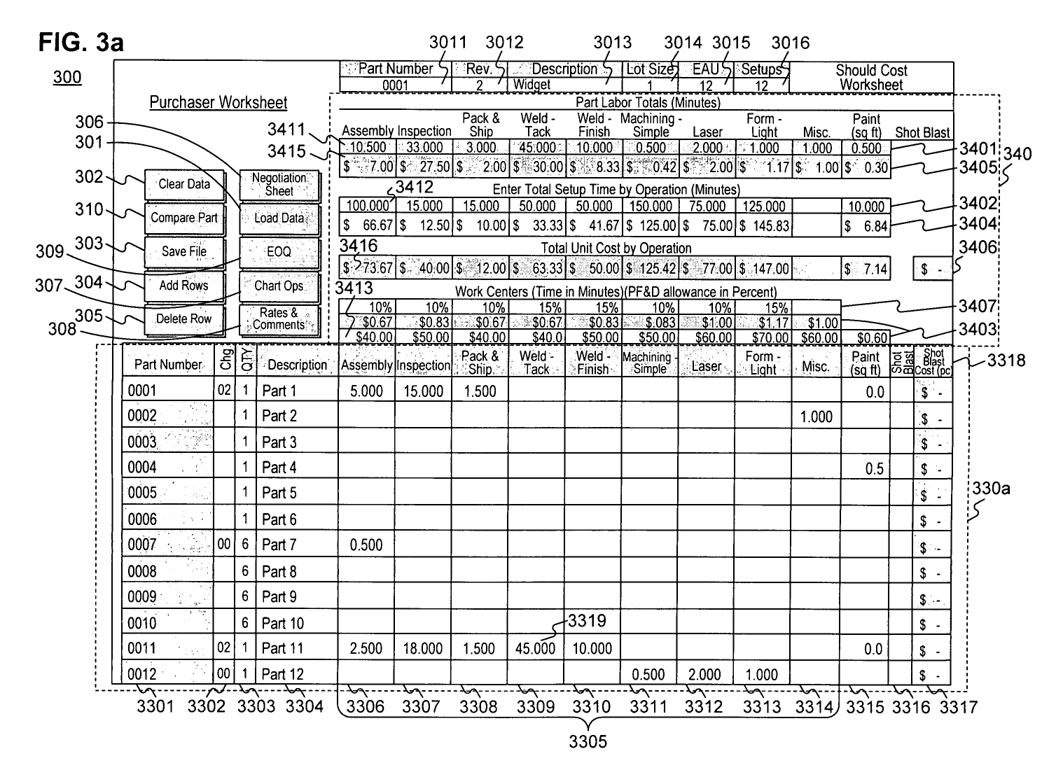

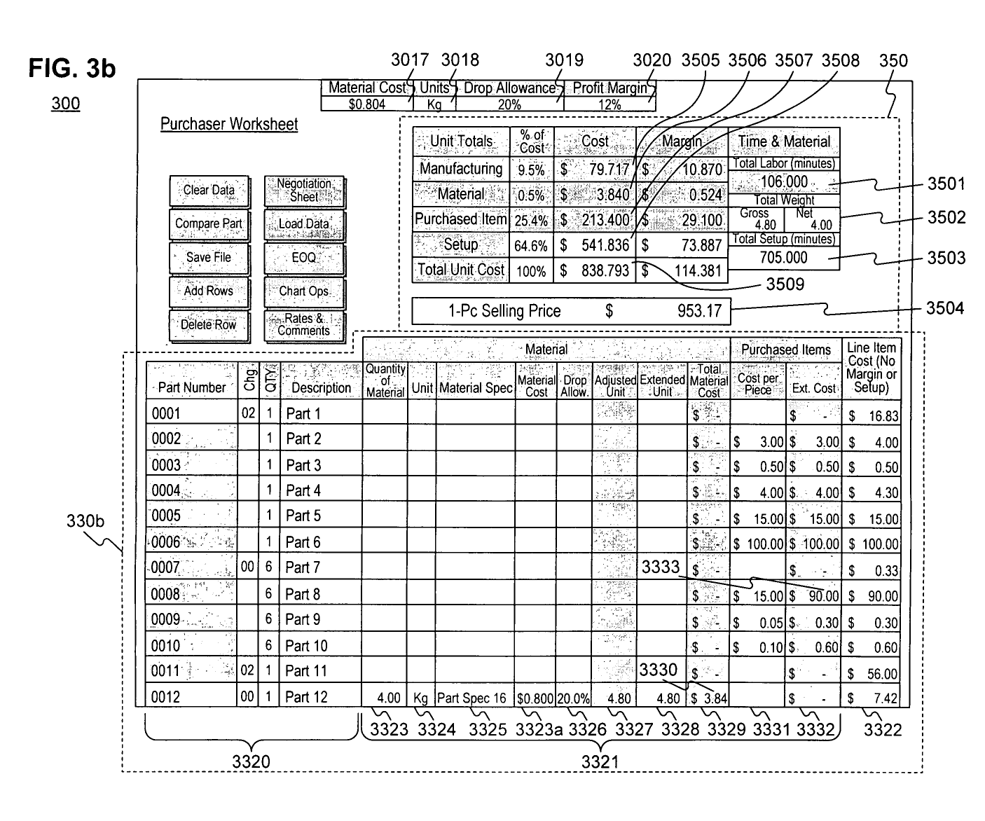

In one embodiment, software application 244 is a spreadsheet application such as Microsoft Excel™ or a similar application. As such, in one embodiment, a data file may be imported into software application 244 in a structured manner to form a tabular spreadsheet including associated buttons, as depicted in FIGS. 3a and 3b. Although described herein as an exemplary spreadsheet application, software application 244 may be any computer program capable of implementing the methods described herein.

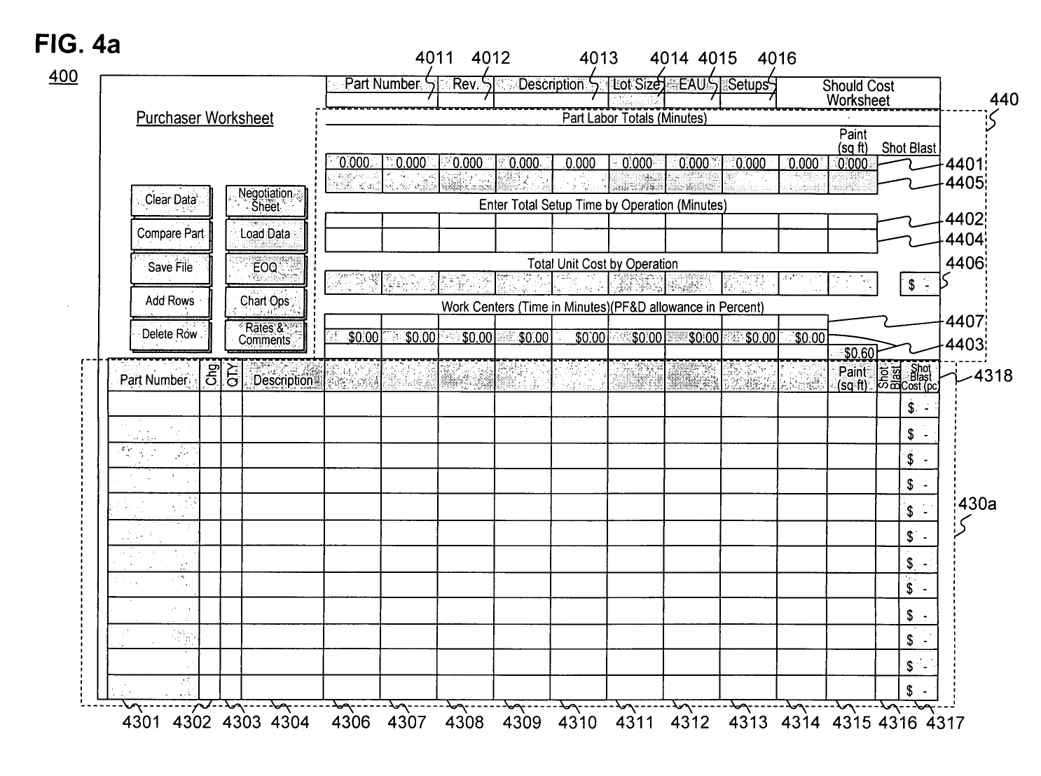

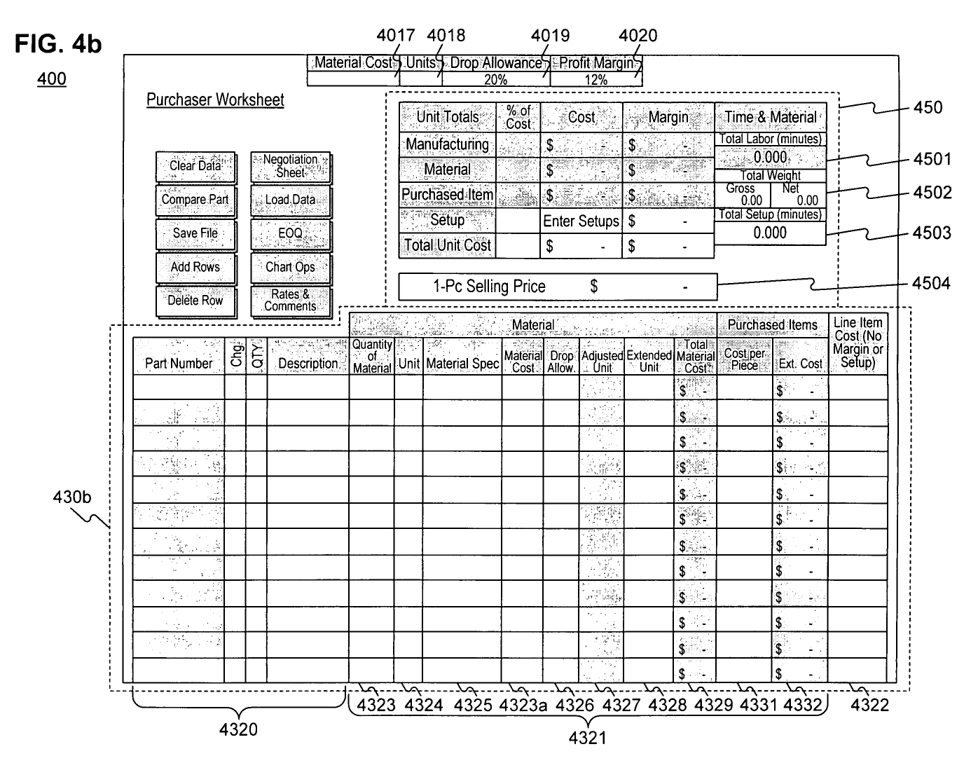

FIGS. 3a, 3b, 4a, and 4b are exemplary embodiments of should-cost negotiation spreadsheets 300 and 400 used to negotiate purchase prices of assembled goods. Although FIGS. 3a and 3b appear on two separate sheets, in one embodiment, they are combined on a single sheet or a single screen to allow a user to view and/or enter all of the displayed information on a single sheet. Similarly, in one embodiment, FIGS. 4a and 4b are combined on a single sheet or screen to allow a user to view and/or enter a set of information on a single sheet. Thus, for example, the lower portion of both FIGS. 3a and 3b displaying rows related to different part numbers (e.g., 0001, 0002, etc.) may be combined into a single table, having a set number of rows (e.g., 13 rows in FIGS. 3a and 3b) and a set number of columns (e.g., 27 columns in FIGS. 3a and 3b). In one embodiment, the upper portions of FIGS. 3a and 3b are then displayed above the combined lower portion. The spreadsheet shown in FIGS. 4a and 4b may be combined in a similar manner. In one embodiment, spreadsheets 300 and 400 are scrollable files.

FIGS. 4a and 4b show a blank negotiation sheet before being populated, while FIGS. 3a and 3b show a negotiation spreadsheet 300 after being populated with should-cost data. In one embodiment, as described further below, a purchaser begins with a blank spreadsheet, such as shown in FIGS. 4a and 4b, as negotiation spreadsheet 400. The purchaser then uses data import module 242 to load data into the blank spreadsheet to create populated negotiation spreadsheet 300, alters spreadsheet 300 using one or more computer program tools, and then sends (via postal mail, e-mail, etc.) a blank version of spreadsheet 300, as shown in FIGS. 4a and 4b as negotiation spreadsheet 400, to the supplier. In one embodiment, the blank version sent to supplier may have certain rows, columns, and/or individual cells locked so that the supplier cannot change some data values or predetermined formulas, such as functions that calculate total should-cost values. The supplier then manually may enter data into one or more data entry locations (e.g., cells on an Excel™ spreadsheet) to create a populated version of the supplier negotiation spreadsheet. In one embodiment, spreadsheets 300 and 400 visually distinguish locked cells from unlocked cells based on color or shading (e.g., white cells are unlocked, and shaded cells are locked), although other types of indicators may be implemented. In this embodiment, color-coding or shading is only used as visual aid, and does not necessarily indicate that a certain cell is locked or unlocked.

In one embodiment, spreadsheet 300 begins as a blank spreadsheet (i.e., as shown in FIGS. 4a and 4b as spreadsheet 400) having certain data locations (e.g., cells) filled with text and/or formulas and other data locations (e.g., cells) empty. In one embodiment, spreadsheet 300 may include active buttons that perform some function upon selection. For example, upon a user clicking on the “Load Data” button 301, a selection area may be displayed (e.g., a folder, menu, text entry box, etc.) that permits the user to select a set of information associated with an assembled good to load and display on the spreadsheet. In one embodiment, the user may select from a folder or other storage area that stores one or more data files of information extracted from supply parts database 240. In another embodiment, the user may selectively load data directly from supply parts database 240 into the spreadsheet. After the user selects the data to load, the blank spreadsheet is automatically populated with data, such as the data shown in FIGS. 3a and 3b.

The data loaded into spreadsheet 300 includes information associated with a selected assembled good. The information includes parts used to manufacture the assembled good, material-specific information related to the parts, processes necessary to manufacture the assembled good, fee rates for the processes, and additional information. In one embodiment, the information is derived from a bill of materials associated with the assembled good. For example, in the embodiment shown in FIGS. 3a and 3b, a set of data associated with a selected assembled good named “Part Number 0001” is loaded into the spreadsheet.

The top two rows of spreadsheet 300 include certain information for the assembled good. For example, part number cell 3011 includes the part number of the selected assembled good (e.g., “0001”). The part number may be assigned by the purchaser, the supplier, another party, etc. Revision cell 3012 includes an engineering change level number for the assembled good (e.g., “2”). Description cell 3013 includes a description of the assembled good (e.g., “Widget”).

Lot size cell 3014 includes the number of assembled goods in a lot (e.g., 1). Typically, assembled goods are manufactured in lots, or groups. Each time one lot of goods is manufactured, the manufacturing process requires assembly equipment and machinery to be set up. Thus, each separate lot of assembled goods manufactured requires a separate setup, and incurs a separate setup cost. The number of assembled goods manufactured in one lot can be any desired amount, but may depend, for example, on a combination of the number of assembled goods desired by a purchaser (e.g., on an annual basis) and the number of setups (e.g., per year) desired by a supplier.

Estimated annual usage cell 3015 (e.g., “EAU”) represents the estimated annual number of assembled goods to be used by (i.e., delivered to) the purchaser (e.g., 12). Although described herein as “annual” usage, the estimated usage may be based on any time period (e.g., monthly, bi-annually, etc.). Setups cell 3016 includes the annual number of setups needed to produce the estimated annual usage quantity (e.g., 12) given the desired lot size (e.g., 1). Thus, in order to ensure that enough assembled goods are manufactured for a purchaser each year, the number of setups per year multiplied by the lot size per setup (lot size is also referred to herein as “order quantity” because it represents a number of assembled goods manufactured per manufacturing order) must be equal to or greater than the EAU. As an example, for the numerical data described above, 12 setups would be required to manufacture the estimated annual usage of 12 widgets (part number 0001), where the lot size (e.g., number of widgets manufactured for each setup) is 1.

Although each setup results in the manufacture of a certain number of assembled goods (i.e., the lot size), the supplier of the assembled goods, who may also be the manufacturer, may not necessarily deliver the entire lot to a purchaser at once. For example, in a situation where the annual number of setups is 1 and the order quantity is 12, the purchaser may not desire to or be able to store all 12 assembled goods in inventory for the year. Thus, a situation arises where the supplier is forced to store a number of assembled goods in inventory. The higher the order quantity, the greater the number of assembled goods that the supplier will likely need to store in inventory.

As shown in FIG. 3b, material cost cell 3017 and units cell 3018 include a material cost per pound or kilogram of material. The value in cell 3017 (e.g., $0.804) represents an average material cost per kilogram for all combined materials needed to manufacture the assembled good. Drop allowance cell 3019 includes information reflecting a percent increase in the overall assembled good material weight to account for the original weight of the material before processing (e.g., including plate or sheet skeletal weight, etc.). Profit margin cell 3020 includes an expected or desired profit margin for the assembled good.

The lower portion of spreadsheet 300, including portion 330a (FIG. 3a) and 330b (FIG. 3b) includes a table having rows of part numbers. For each part number, portions 330a and 330b include: columns for storing information related to processes (i.e. “operations”) necessary to manufacture the assembled good (shown in 330a); columns for storing information related to part material (shown in 330b); and columns for displaying total costs (shown in 330b). The number of rows in portion 330a and 330b varies depending on the number of parts needed to manufacture the assembled good (e.g., the number of parts imported into the spreadsheet). Similarly, the number of columns in portion 330a, and the particular processes included in those columns, also varies depending on the number of processes necessary to manufacture the assembled good (e.g., the number of different processes imported into the spreadsheet).

Portion 330a of FIG. 3a includes a number of exemplary columns according to one embodiment in which data related to a “widget” is imported into spreadsheet 300. For example, part number column 3301 includes data reflecting a part number for each part used in an assembled good (e.g., “0002,” “0003,” etc., used in assembled good 0001). Change column 3302 includes data reflecting the engineering change level of the part (e.g. “00,” “02,” etc.). Quantity column 3303 includes data reflecting the number of parts used to manufacture the assembled good (e.g., six “part 7” parts, one “part 11” part, etc., used to manufacture assembled good 0001). Description column 3304 includes data reflecting a description of each listed part.

Process columns 3305 each include a time amount reflecting the time (in minutes) required for each process used in manufacturing an assembled good. For example, in one embodiment, process columns 3305 include: assembly column 3306 reflecting the time needed to assemble each part listed in part number column 3301; inspection column 3307 reflecting the time needed to inspect each part listed in part number column 3301; pack & ship column 3308 reflecting the time needed to pack and ship each part listed in part number column 3301; weld-tack column 3309 reflecting the time needed to tack weld each part listed in part number column 3301; weld-finish column 3310 reflecting the time needed to finish welding each part listed in part number column 3301; machining-simple column 3311 reflecting the time needed to perform simple machining operations on each part listed in part number column 3301; laser column 3312 reflecting the time needed to perform laser cutting on each part listed in part number column 3301; form-light column 3313 reflecting the time needed to light-form each part listed in part number column 3301; and miscellaneous column 3314 reflecting additional time needed for miscellaneous processes. Paint per square foot column 3315 includes data reflecting an area of square feet to be painted. Shot blast column 3316 includes an indicator reflecting whether shot blasting is necessary for the part (e.g., “yes” could be indicated by a “y,” a “yes,” a checkmark, etc.; “no” could be indicated by a “n,” a “no,” a non-entry, etc.). Shot blast cost column 3317 indicates a cost for shot blasting each part.

The columns included in portion 330a are exemplary only, and depend on the information imported into the table and/or information entered into the table by a user. For example, process columns 3305 may include additional blank columns (not shown) that permit a user to enter additional processes to the spreadsheet. Alternatively, process columns 3305 may include fewer columns than those shown (e.g., if one or more of the depicted processes is not necessary to manufacture a particular assembled good). In one embodiment, additional blank columns (not shown) are included in columns 3305. Each blank column may be manually altered to include both a process name (e.g., in row 3318) and time amounts (e.g., in the remaining rows for each part). In one embodiment, when a user selects a blank cell in row 3318 (e.g., clicks with a mouse or other pointing device), a drop down list appears, which lists a number of possible processes from which the user can select. Alternatively, or additionally, the user may type in a process into a blank cell in row 3318. Furthermore, although certain data values are automatically placed into columns 3305, a user can alter those data values if the user desires. For example, if the user believes that the time of 45 minutes for tack welding of part 0011 is incorrect, the user can manually adjust the value for that process (e.g., shown in cell 3319) by entering a different value.

Portion 330b of FIG. 3b includes a number of exemplary columns related to the same “widget” discussed in connection with FIG. 3a. Thus, the part number, chg, quantity, and descriptions columns 3320 of FIG. 3b correspond to respective columns 3301-3304 of FIG. 3a. Portion 330b additionally includes columns 3321, which include information relating to material and purchased items associated with each part, and further includes column 3322, which includes line item costs for each part.

For example, columns 3321 may include: quantity of material column 3323 and unit of weight column 3324, which include data reflecting the weight of the material used in the part; material spec column 3325, which includes additional specification information about the part material; material cost column 3323a, which includes data reflecting a cost per pound or kilogram for the material for each part listed in part number column 3301; drop allowance column 3326, which includes data reflecting a percent increase in the part weight to account for the original weight of the material before processing (e.g., including plate or sheet skeletal weight, etc.); adjusted unit column 3327, which includes data reflecting the material quantity adjusted for the drop allowance (e.g., taking part 0012 as an example, 120% of the value in quantity of material column 3323); extended unit column 3328, which includes data reflecting the adjusted unit value multiplied by the quantity of parts value in quantity column 3303; total material cost column 3329, which includes data reflecting the extended unit value multiplied by the material cost (e.g., $3.84, as shown in cell 3330); cost per piece column 3331, which includes data reflecting costs of parts or services that are purchased (e.g., from another supplier, etc.) to complete the associated part number (e.g., nuts, washers, bolts, heat treating, plating, special testing, etc.); and extended cost column 3332, which includes data reflecting the cost per piece multiplied by the quantity of parts value in quantity column 3303 (e.g., $90.00, as shown in cell 3333).

Portion 330b further includes line item cost column 3322. The line item cost for each part, includes the cost of material associated with the part added to the cost for processing the part (excluding any setup time costs). Additional columns may be added to portion 330b of spreadsheet 300 including columns related to additional assembled good-related information.

Referring to FIG. 3a, the processing rates, processing costs, setup costs, and total costs associated with each process are displayed in portion 340. Portion 340 includes a number of rows for each process included in portion 330a. For instance, process labor time row 3401 includes, for each process, data reflecting the total accumulated time needed to run the process in order to make one assembled good. For example, as shown in spreadsheet 300, cell 3411 includes the value “10.500,” which reflects the number of total minutes necessary for the “assembly” operation when manufacturing one assembled “0001” good (e.g., the sum of 3 minutes for assembling six “Part 0007s,” 2.5 minutes for assembling one “Part 0011,” and 5 minutes for assembling the one “Part 0001”).

Setup time row 3402 includes data reflecting total setup time needed for each process. Each process (e.g., assembly, inspection, pack & ship, etc.) has an associated setup time, which may include, for example, time needed to set up the equipment used for the process (e.g., warming up a welding machine, calibrating assembly equipment, etc.). For instance, as shown in spreadsheet 300, cell 3412 indicates that assembly operations will require 100 minutes of overall setup time. The setup time value for each process may be imported from database 240 or from stored data files using import module 242. Alternatively, or additionally, the setup time values may be manually entered or altered by a user.

Process rate rows 3403 include data reflecting operation rates (e.g., dollars per hour, dollars per minute, etc.) for each process. For example, cell 3413 includes data reflecting a rate of $40.00 per hour for the “assembly” process. Each process includes an associated rate used to calculate the overall should-cost for that process. In one embodiment, the rates in rows 3403 are rates for both process operation and process setup. However, in other embodiments, these rates may differ and may be stored in different locations within spreadsheet 300. The process operation and setup rate for each process may be imported from database 240 or from stored data files using import module 242. Alternatively, or additionally, the process rate values may be manually entered or altered by a user.

Process labor cost row 3405 includes data reflecting the total cost for operating each process. In one embodiment, the total labor cost stored in process labor cost row 3405 for each process is calculated by multiplying the process time value stored in process labor time row 3401 by the process rate (e.g., dollars per minute) stored in process rate rows 3403. For example, cell 3415 includes data reflecting a total process labor cost of $7.00 (e.g., 10.5 total minutes multiplied by an hourly rate of $40 per hour). Process setup cost row 3404 includes data reflecting the total setup cost for each process. In one embodiment, the setup cost stored in process setup cost row 3404 for each process is calculated by multiplying the process setup time value stored in setup time row 3402 by the rate value stored in one of process rate rows 3403.

Total unit cost row 3406 includes data reflecting the total cost per assembled good for the combined setup and operation of each process. For example, the total “assembly” cost of $73.67 in cell 3416 is calculated by adding the total setup cost for “assembly” (e.g., $66.67) stored in process setup cost row 3404, divided by the lot size stored in cell 3014 (e.g., 1), to the total “assembly” labor cost stored in process labor cost row 3405 (e.g., $7.00).

PF&D row 3407 includes additional data reflecting a “personal fatigue and delay” percentage associated with each process. This value indicates an expected inefficiency of the process, based on expected time deficiencies resulting from employee or other inefficiencies. The PF&D value may reflect one or more personal fatigue values associated with, for example, employee fatigue, and/or may reflect one or more other values associated with process delays. For example, a value of 10% may represent a percent decrease in productivity due to employee fatigue. Alternatively, or additionally, a value of 10% may reflect a percent delay due to process inefficiencies. The values in PF&D row 3407 may be used as a weighting coefficient for adjusting overall time values stored in process labor time row 3401 before calculating a labor process cost. Thus, a value of 10% may indicate that stored time values should be increased by 10% to account for inefficiencies associated with the process. Alternatively, the values stored in PF&D row 3407 may serve as mere indicators of expected inefficiencies during the manufacturing process. The PF&D values may be imported from database 240 or from stored data files using import module 242. Alternatively, or additionally, the PF&D values may be manually entered or altered by a user.

Accordingly, purchaser system 112 may include each of rows 3401-3407 in spreadsheet 300, to enable purchaser 110 to better understand and more easily view and alter the specific variables used to determine the should-cost price for a particular assembled good.

In one embodiment, additional data is displayed in portion 350 of spreadsheet 300, shown in FIG. 3b. Portion 350 of spreadsheet 300 shows a table that stores additional information associated with the should-cost of assembled goods. Portion 350 provides should-cost values for different categories. In one embodiment, the categories include: a total manufacturing cost 3505 per assembled good, calculated by summing the values stored in the cells of process labor cost row 3405; a total material cost 3506 per assembled good, calculated by summing the values stored in the cells of total material cost column 3329; a total purchased item cost 3507 per assembled good, calculated by summing the values stored in the cells of extended cost column 3332; a total setup cost 3508 per assembled good, calculated by summing the total setup cost values in process setup cost row 3404 and dividing the resulting value by the lot size in cell 3014; and a total unit cost 3509 per assembled good, calculated by adding the total manufacturing cost 3505, total material cost 3506, total purchased item cost 3507, and total setup cost 3508. In one embodiment, portion 350 of spreadsheet 300 includes a profit margin cost for each of the above categories. The profit margin costs reflect the desired or expected profit margin stored in cell 3020. As shown in portion 350 of spreadsheet 300, the total costs and profit margin costs may be stored in different columns of a table. The table may store additional total values, such as a total labor time per assembled good (cell 3501), total material weight per assembled good (cells 3502), and total setup time per lot (cell 3503). Furthermore, the table includes a total should-cost cell (3504), which displays the total overall should-cost price (e.g., $953.17) for an assembled good. In one embodiment, this total value accounts for setup time costs, processing costs, material costs, purchased items costs, and profit margin (e.g., (Total manufacturing cost per assembled good+total material cost per assembled good+purchased item cost per assembled good+setup cost per assembled good)×(1+profit margin)), as described above.

Spreadsheet 300 may include additional buttons 301-310 that perform preset functions when selected. As discussed previously, load data button 301, when selected, permits a user to select an assembled good and load its associated should-cost data into a blank version of spreadsheet 300. This selection causes spreadsheet 300 to be populated with should-cost data (e.g., the data shown in FIGS. 3a and 3b). Clear data button 302, when selected, clears the data stored in certain cells of spreadsheet 300. For example, in one embodiment, selecting the clear data 302 button for a spreadsheet such as shown in FIGS. 3a and 3b will clear cells 3011-3018 as well as certain cells in portions 330a, 330b, 340, and 350, resulting in a spreadsheet such as shown in FIGS. 4a and 4b. In one embodiment, selecting the clear data button 302 causes only unlocked cells with either numerical data or textual data to be cleared. As such, cells that are locked or that contain formulas (e.g., cells in rows 3401, 3404, 3406, etc., columns 3327, 3328, 3329, etc., spreadsheet portion 350, and other pre-set cells) will not be cleared, although they may display a null value (e.g., may be blank) if, for example, they contain formulas that refer to cleared cells.

Save file button 303, when selected, permits a user to save the data stored in the spreadsheet. Add rows button 304, when selected, permits a user to add one or more rows to portion 330a and 330b. For example, a user may discover an additional part that must be included in an assembled good. In such a case, the user may select the add rows button 304 and one or more new rows may be added to spreadsheet 300. Delete rows button 305, when selected, permits a user to delete one or more rows from portion 330a and 330b. For example, a user may discover that one or more parts listed in portion 330a and 330b of spreadsheet 300 may no longer be necessary. In such a case, the user may select the delete rows button 305 to delete the appropriate rows from spreadsheet 300.

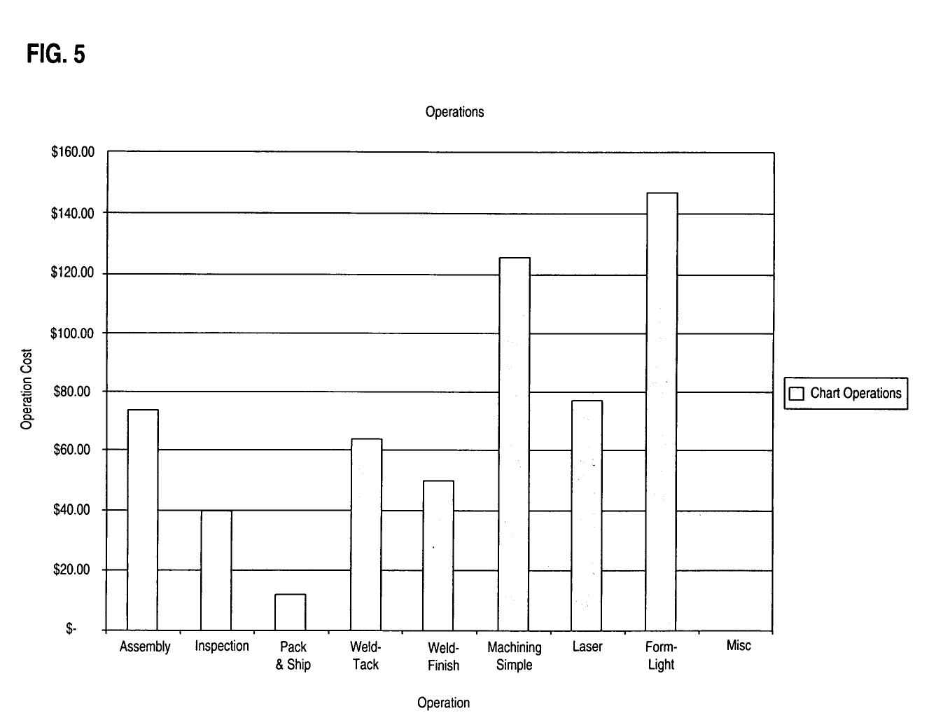

Negotiation sheet button 306, when selected, copies the entire spreadsheet and inserts it into a blank spreadsheet (e.g., into a new worksheet in Microsoft Excel™), thus permitting a user to compare two versions of a should-cost spreadsheet without opening a new spreadsheet file. Chart ops button 307, when selected, creates a chart that graphically depicts the values stored in total unit cost row 3406. An example of such a chart is shown in FIG. 5. By displaying a chart, as shown in FIG. 5, a purchaser or supplier can easily determine which processes are the most expensive. Thus, using chart ops button 307 provides information that reduces resources used by a purchaser or supplier to perform mathematical comparisons of process costs. Instead, the purchaser or supplier may review the proportional differences between process costs by viewing a chart, such as that shown in FIG. 5.

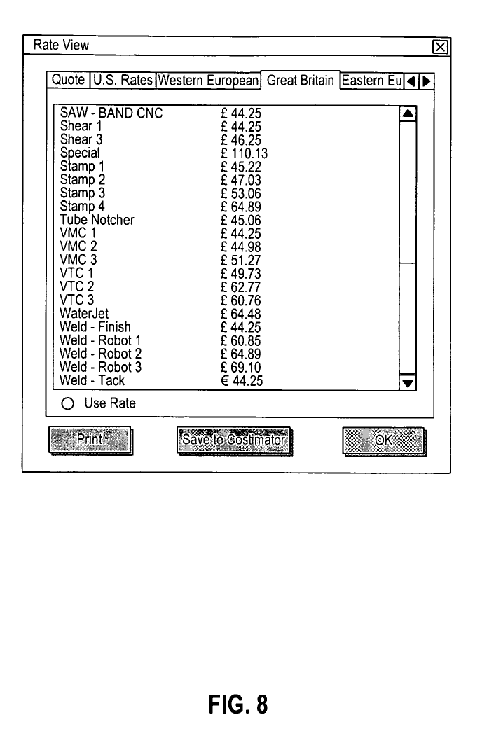

Rates and comments button 308, when selected, may open a pop-up window that displays one or more rates for different processes and provides a text entry portion that allows the purchaser or supplier to enter comments. In one embodiment, rates and comments button 308 includes a number of sheets selectable by tabs, each sheet listing rates for a number of processes in a specific currency. A user may then select one of the currencies as the rate for calculating and entering data into spreadsheet 300. An exemplary pop-up window is shown in FIG. 8.

Compare part button 310, when selected, permits a user to compare various information about two assembled goods together in a new file or page. In one embodiment, a user selects compare part button 310, which causes a selection box (not shown) to appear which allows the user to select another file for a second assembled good for comparison with the first assembled good included in spreadsheet 300. As a result of the selection, the Excel™ program or other computer program automatically creates a new file (e.g., spreadsheet) or page (e.g., worksheet), and includes in the file or page information (e.g., part number; EAU; number of setups per year; costs of material, labor, etc.; labor time; setup time; rates; etc.) for each respective assembled good. In one embodiment, the information for the first assembled good may be displayed in a first row of the new file or page, and the same type of information for the second assembled good may be displayed in a second row of the new file or page. In this way, the user may then compare on a single page the different data for the two assembled goods, and may select a most desired (e.g., most cost-efficient, time-saving, etc.) assembled good to purchase or sell. The two assembled goods may be the same type of assembled good having different associated information (e.g., same part number, but having different number setups per year, setup times, etc.), or may be different types of assembled goods.

EOQ button 309, described further below, initiates a computer program tool that permits a user to estimate an optimal number of setups per year and an optimal order quantity, and also permits a user to estimate an optimal should-cost purchase price.

As described above, FIGS. 3a and 3b show an exemplary populated spreadsheet 300 consistent with certain disclosed embodiments. Although the data in spreadsheet 300 includes certain values, these values are given as examples only, and will vary depending on the assembled good information loaded and/or manually entered into the spreadsheet. For example, although spreadsheet 300 includes 12 part number rows and 11 process columns, the number and type of columns and rows may vary.

FIGS. 4a and 4b show an exemplary embodiment of a negotiation spreadsheet 400 before being populated with assembled good-specific information. The negotiation spreadsheet will be in this un-populated state either before any data is loaded and/or entered into the spreadsheet, or after a user selects the “clear data” button. The rows in portion 440 of spreadsheet 400 correspond to respective rows in portion 340 of spreadsheet 300, and thus contain the same type of information (and the same formulas where the cells include formulas). Similarly, the columns in portion 430b of spreadsheet 400 and the cells in portion 450 of spreadsheet 400 correspond to respective columns in portion 330b and cells in portion 350 of spreadsheet 300.

Negotiation spreadsheet 400 may be in an “unlocked” state, in which a user can view all formulas, alter all values, and use all buttons, or may be in a “locked” state, in which a user is only permitted to view and enter certain information and use certain buttons. In one embodiment, a purchaser (e.g., purchaser 110) uses spreadsheet 400 in an unlocked state, and then sends a locked negotiation spreadsheet 400 to a supplier. In one embodiment, the locked spreadsheet does not permit the supplier to use the “load data” button, and also does not permit the supplier to alter any cells in the spreadsheet that contain formulas. Other cells may be locked as well.

In one embodiment, when spreadsheet 400 is sent to a supplier, all data cells that are to contain data used to calculate the total overall should-cost of an assembled good remain unlocked. For example, in one embodiment, cells 4011-4020, and cells in portion 430a, columns 4301-4316, including cells in row 4318, are unlocked to allow the user to enter part information, part quantity, process type and time, lot size, drop allowance, profit margin, etc. Furthermore, in one embodiment, cells in rows 4403 (process rates), 4407 (personal fatigue and delay percentage), and 4402 (setup time) are also unlocked to allow the user to enter process rate values, PF&D values, and setup time values. In one embodiment, the cells in row 4318 display drop-down lists when selected. These drop-down lists may include suggested names of manufacturing processes. For each cell in row 4318, a user may select any desired process (e.g., using a drop-down list), or may manually enter a process name not listed in the drop-down list.

The disclosed embodiments allow the supplier to enter information that provides an accurate estimate of a should-cost price from the good. The information may include, for example, the name of each process, expected time for each process for each part, process rate for each process, setup time for each process, quantity of each part per assembled good, quantity of material used for each part, material cost for each part, drop allowance for each part, cost per piece of purchased items for each part, lot size, material cost, drop allowance, and profit margin, etc. Further, because the supplier is not required to select a specific process rate for each process, but rather may input any desired rate, the supplier does not have to artificially inflate inputted time values to ensure that the total overall should-cost price is a particular value. Also, because the supplier is able to provide information for any type of process, the supplier has greater flexibility in determining a should-cost price and may organize the display of the should-cost spreadsheet as desired. In addition, by permitting the supplier to enter personal fatigue and delay values, the supplier can better convey expected inefficiencies to a purchaser, thereby better estimating an expected should-cost price.

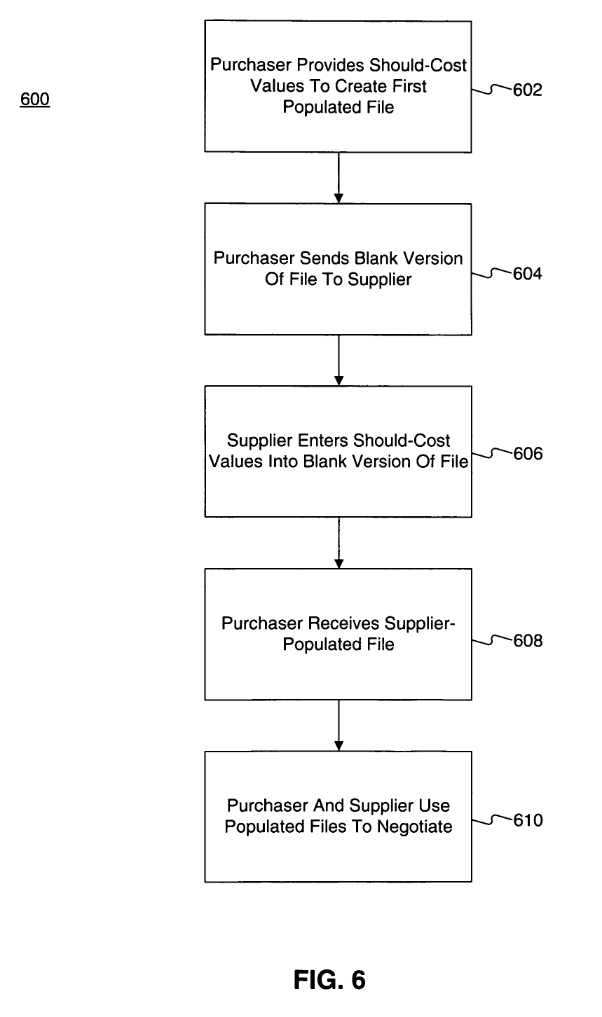

FIG. 6 shows a block diagram of an exemplary embodiment of a negotiation method that utilizes a should-cost negotiation file, such as a spreadsheet described above in connection with FIGS. 3a, 3b, 4a, and 4b. In step 602, a purchaser provides should-cost values to a first file to create a first populated file. The values may be provided to the first file by a single selection process (e.g., by selecting an assembled good from a displayed list after clicking on a load button), and/or by one or more manual entries (e.g., by entering values into the file). In one embodiment, the values are determined based on an optimization process using computer program tool 700, as described further below. In one embodiment, the provided values include part numbers, EAU, lot size, number of setups per year, operation (i.e., process) names, time entries for each operation and part number, operation rate information (e.g., dollars per hour), setup time entries for each operation, material cost for each part, and other information (e.g., information such as shown in FIGS. 3a and 3b). Based on the entered information, the file automatically populates certain data structures (e.g., cells) that include one or more formulas or logical expressions that refer to the entered information (e.g., rows 3404, 3405, etc., as described above in connection with FIGS. 3a and 3b). In one embodiment, one of these data structures is a total overall should-cost price cell that displays the total overall should-cost price of the assembled good.

In step 604, the purchaser sends a blank version of the first file to a seller of the assembled good (e.g., a supplier). The blank version may be transmitted electronically, sent by postal mail (e.g., via CD ROM or other computer-readable memory storage device), hand delivered, or sent in any other way to the seller. In one embodiment, the blank version includes locked cells and unlocked cells, such as those described previously in connection with FIGS. 3a, 3b, 4a, and 4b. In one embodiment, the blank version includes entry areas that permit the seller to enter should-cost values that include at least a cost rate value associated with performing and/or setting up an operation associated with the good, and one or more time amount values reflecting the amount of time required to set up and perform the operation on a part. By including these entry areas, the blank version of the spreadsheet permits the seller to enter accurate information regarding manufacturing costs without having to artificially inflate entered time values.

In step 606, the seller enters should-cost values into the blank version of the file. In one embodiment, the values are entered manually by the seller, and include values such as part numbers, operation (i.e., process) names, time entries for each operation and part number, operation rate information (e.g., dollars per hour), setup time entries for each operation, material cost for each part, and other information (e.g., information such as shown in FIGS. 3a and 3b). In entering values, the seller may configure the layout of a data structure representing the file. For example, the seller may manually select any set of operation columns of a spreadsheet to be displayed in any order. The seller may add rows and/or columns to the spreadsheet if necessary. In one embodiment, based on the entered information, the file may automatically populate one or more cells that include one or more formulas or logical expressions that refer to the entered information (e.g., rows 3404, 3405, etc., as described above in connection with FIGS. 3a and 3b). In one embodiment, one of these cells is a total overall should-cost price cell that displays the total overall should-cost price of the assembled good. In a further embodiment, described further below, the seller uses a computer program tool to estimate optimal values related to the assembled good, such as, for example, an optimal order quantity, optimal number of setups per year, and an optimal should-cost purchase price.

In step 608, the purchaser receives the seller-populated file. The file may be received electronically, by postal mail, by hand delivery, or in any other way. In one embodiment, the file may be displayed to the purchaser on a computer screen or other display device (e.g., on the seller's laptop computer). The received file may be in electronic form, paper form, or any other form that permits the purchaser to easily view the contents of the file on a single display or sheet.

In step 610, the purchaser and seller use the seller-populated file and optionally the purchaser-populated file to negotiate a sale price for the assembled good. In one embodiment, for example, the purchaser may view the seller-populated file and suggest a sale price to the seller based on the information displayed in the file. The purchaser and seller may then orally negotiate a price. In another embodiment, both the purchaser and the seller may open electronic versions of their respective files (e.g., using a software program such as Microsoft Excel™). The purchaser and seller may then discuss and/or view each others' spreadsheets and may alter the values in the files by entering data using a keyboard, mouse, or other type of input mechanism. In another embodiment, the purchaser and seller may select compare part button 310 to compare their should-cost values in a new sheet or file.

After the parties agree on a sales price, information from the spreadsheet that has the agreed-upon, final price may be used to create and draft a binding sales contract. This information may include, for example, one or more of: a part number, purchase price, lot size, number of setups per year, part costs, labor costs, etc. The assembled goods may then be manufactured and delivered to the purchaser according to the terms of the contract, and the agreed-upon price may be paid. Although specific negotiation examples are given, any method of negotiation may be used, as would be appreciated by one skilled in the art. For example, the order of steps depicted in FIG. 6 may vary.

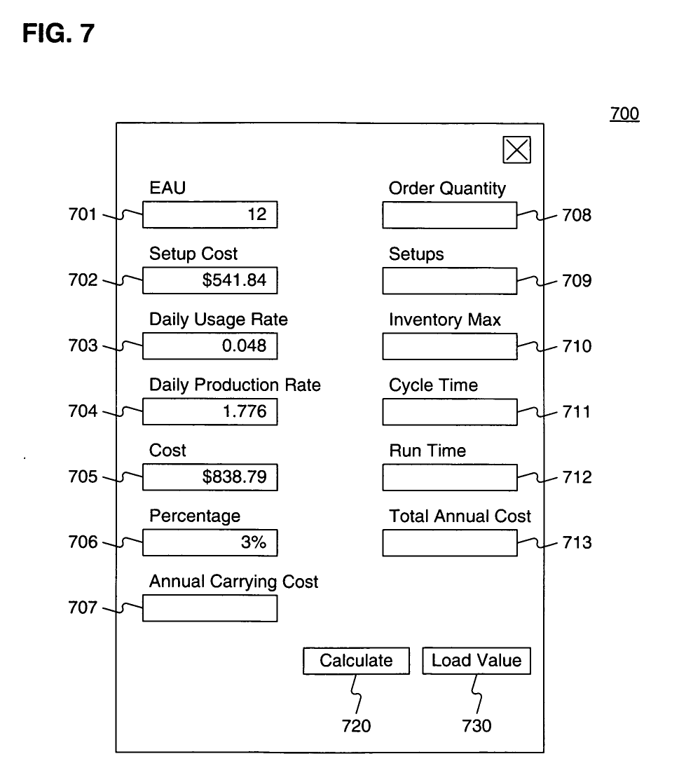

In a further embodiment, a computer program tool, such as computer program tool 700 shown in FIG. 7, is provided. Computer program tool 700 may be part of a computer program, such as, for example, Microsoft Excel™, which permits users to create macros using code such as Visual Basic™, to store and use mathematical equations and boolean expressions, to use entry boxes, and to employ other tools. In one embodiment, computer program tool 700 permits a purchaser and seller to estimate an optimal number of setups per year and an optimal order quantity to minimize costs for assembled goods, based on an estimated annual usage of the assembled goods and other information. Both the supplier and the purchaser may use the tool to negotiate an optimal should-cost purchase price for assembled goods. In one embodiment, a computer program tool may be opened by a user selecting a button or other selectable item, such as EOQ button 309 depicted in FIG. 3a.

In one embodiment, as a result of button 309 being selected, computer program tool 700 is displayed to a user. This tool permits the user to determine an optimal number of setups per year and an optimal order quantity for a supplier in order to minimize overall costs for the supplier, resulting in a lower purchase price for the purchaser. Based on these optimal values, the tool permits the supplier and purchaser to negotiate an optimal should-cost purchase price for the assembled goods.

For assembled goods provided by a supplier and purchased by a purchaser, the purchase price will vary depending on the manufacturing cost and the cost to the supplier of carrying the assembled goods in inventory. For example, if a purchaser's EAU is 12, the supplier may implement one setup per year, with an order quantity of 12, may implement twelve setups per year with an order quantity of 1, or may implement any variation in between. If the order quantity is 12, the supplier reduces manufacturing costs by requiring only one setup for all 12 assembled goods, but increases carrying costs by expending the entire manufacturing cost for the year at once, thereby losing the opportunity to invest the money and obtain interest or other capital. If, on the other hand, the order quantity is one, requiring 12 setups, the supplier reduces carrying costs, but increases manufacturing costs due to the increased number of setups required.

Typically, for a given EAU, carrying costs increase linearly in relation to order quantity, while manufacturing costs decrease in a non-linear manner in relation to increased order quantity. The point where the two curves cross may represent a minimal overall cost, and indicates an optimal order quantity that results in the minimal overall cost. A discussion of economic order quantity and the cost curve can be found in William J. Stevenson, Production Operations Management 567-73, Sixth Edition, Irwin/McGraw-Hill, 1999.

In one embodiment, computer program tool 700 includes a number of cells 701-713 and buttons 720 and 730. Although FIG. 7 depicts certain display and/or entry cells and selection buttons, any known display, entry, and selection mechanisms may be used to implement computer program tool 700 (e.g., drop-down lists, radio buttons, etc.). Certain cells depicted in computer program tool 700 permit a user to enter values and/or permit automatic entry of values from spreadsheet 300 (e.g., cells 701-706). Other cells only calculate values and do not permit user entry (e.g., cells 707-713).

In one embodiment, upon selection of EOQ button 309, cells 701-706 are automatically populated with default values and/or values derived from data contained in spreadsheet 700. Exemplary values are shown in FIG. 7 that reflect the information depicted in spreadsheet 300 of FIGS. 3a and 3b. The values in cells 701-706 may be changed by a user if desired and may be rounded if desired. EAU cell 701 includes an estimated annual usage (EAU) value, which may be obtained from cell 3015 of spreadsheet 300, and which reflects the estimated number of assembled goods to be used by (i.e., delivered to) the purchaser per year. Setup cost cell 702 includes a setup cost value which may be obtained from cell 3508 of spreadsheet 300, and which reflects the manufacturing setup cost to set up machines and other equipment in order to manufacture one assembled good. Daily usage rate cell 703 includes an estimated daily usage derived by dividing the EAU value by a number of expected days of usage of the assembled goods in one year (e.g., 250 business days, etc.), and thus reflects the estimated number of assembled goods to be used by the purchaser each day. Daily production rate cell 704 includes a daily production rate value (e.g., number of assembled goods manufactured in one day) derived from the total labor time per assembled good (e.g., from cell 3501), the total setup time per lot (e.g., from cell 3503), and the lot size (e.g., from cell 3014) (e.g., lot size×60×24/(total labor time per assembled good×lot size+setup time per lot)), and thus reflects the number of assembled goods that can be made in 24 hours. Cost cell 705 includes the cost of manufacturing one assembled good, which may be obtained from total unit cost cell 3509. Percentage cell 706 includes a cost of money value which may represent an interest rate or other percentage gain which represents the opportunity cost for spending money on manufacturing assembled goods rather than investing the money elsewhere. In one embodiment, the value in percentage cell 706 is set as a default based on the state of the market.

In one embodiment, after computer program tool 700 is displayed with values in cells 701-706, a user may select calculate button 720 to cause cells 707-713 in computer program tool 700 to be populated. Cells 707-713 may represent additional values and may be populated (not shown) based on the values in cells 701-706 and other values in spreadsheet 300. In one embodiment, cells 707-713 are populated as a result of macros, stored equations, and/or other computer program instructions that cause the cells to be automatically populated.

In one embodiment, annual carrying cost cell 707 includes the opportunity cost to the supplier of spending money to manufacture or have manufactured the assembled goods rather than investing the money elsewhere. The annual carrying cost may be calculated, for example, by determining the future return on an investment using the value of cost cell 705 as the present value and the value of percentage cell 706 as the interest rate.

In one embodiment, order quantity cell 708 includes an order quantity that minimizes carrying costs and manufacturing costs based on, for example, the values in EAU cell 701, setup cost cell 702, daily usage rate cell 703, daily production rate cell 704, and annual carrying cost cell 707. In one embodiment, the value in order quantity cell 708 is calculated according to the following formula, and is rounded to the nearest integer:

$$Order Quantity = \sqrt{\frac{2 \times EAU \times setup cost}{annual carrying cost}} \times \sqrt{\frac{daily production rate}{daily production rate - daily usage rate}}$$

In one embodiment, setups cell 709 includes the number of setups required to produce the EAU amount based on the calculated order quantity in cell 708. Thus, the value in setups cell 709 may be calculated by dividing the value in EAU cell 701 by the value in order quantity cell 708. In one embodiment, setups cell 709 is rounded to the nearest integer.

Inventory max cell 710 represents a maximum number of manufactured goods that the supplier will need to store in inventory based on the order quantity in cell 708, daily production rate in cell 704, and daily usage rate in cell 703, and may be calculated according to the following formula:

$$Inventory Max = \frac{order quantity}{daily production rate} \times ( daily production rate - daily usage rate )$$

In one embodiment, the resulting maximum inventory value is rounded to the nearest integer.

Cycle time cell 711 represents the number of days between each setup and may be calculated by dividing the order quantity value in cell 708 by the daily usage rate in cell 703. Run time cell 712 represents the time, in hours, needed to make each lot of assembled goods and may be calculated by dividing the order quantity value in cell 708 by the daily production rate in cell 704. The cycle time value in cell 711 and/or the run time value in cell 712 may be rounded to the nearest decimal or integer.

In one embodiment, total annual cost cell 713 includes a minimum total annual cost at a maximum inventory level per lot of assembled goods. For example, the value in total annual cost cell 713 may be calculated based on the values in cells 710, 707, 701, 708, and 702, according to the following formula:

$$Total Annual Cost = \frac{inventory max}{2} \times annual carrying cost \times \frac{EAU}{order quantity} \times setup cost$$

In one embodiment, the resulting total annual cost in cell 713 may be rounded to the nearest cent.

Thus, after calculate button 720 is selected, computer program tool 700 calculates an annual carrying cost, a number of setups per year and an order quantity, a maximum inventory, a cycle time and run time, and a total annual cost for manufacturing or producing an assembled good. These values may be used by a purchaser and/or supplier to determine a desired number of setups per year and/or the order quantity that the supplier should use in manufacturing or having manufactured the assembled goods.

In one embodiment, after all values in computer program tool 700 are calculated and all cells are populated, a user may select the load value button 730 in order to optimize the values. By selecting load value button 730, the value in setups cell 709 of computer program tool 700 is loaded into setups cell 3016 in spreadsheet 300. This value may further alter the lot size in cell 3014, and may also alter other values that depend on lot size in spreadsheet 300 (e.g., the values in total unit cost row 3406, and the values in portion 350 of spreadsheet 300) and in computer program tool 700 (e.g., the values in setup cost cell 702, daily production rate cell 704, and cost cell 705). The user may then again select the calculate button 720, in order to calculate more refined values based on the new values loaded into the spreadsheet 300 and computer program tool 700. In one embodiment, the user continues this selection process until the selection of either calculate button 720 or load value button 710 does not change any of the data stored in spreadsheet 300 or computer program tool 700. At that point, the values in spreadsheet 300 and computer program tool 700 have reached optimal values that minimize costs to the supplier. In one embodiment, these values may be used by the purchaser and/or supplier in negotiating the number of setups per year, order quantity, should-cost purchase price, and/or other terms related to the assembled goods, and may be used to create and draft a contract between the purchaser and supplier. In addition, once the optimal values are determined and a contract is entered, the optimal number of setups per year and/or order quantity, or approximately similar values (e.g., values affected by typical errors, delays, manufacturing defects, market pressures, etc., associated with the manufacturing process, which may be a percentage variation, such as, for example, up to a 20% variation for smaller order quantities, up to a 5% variation for larger order quantities, etc.) may be employed by the supplier in manufacturing or having manufactured the assembled goods.

At any point during the optimization process discussed above, the user may change desired values in the spreadsheet 300 (e.g., the EAU value in cell 3015, setups value in cell 3016, or any other values described above capable of being selected and/or entered by a user) or in computer program tool 700 (e.g., percentage cell 706), in order to adjust the desired values. In addition, a user may close the computer program tool 700, change values in spreadsheet 300, and re-start computer program tool 700 in order to re-start the optimization process with newly selected/entered information.

Computer program tool 700 provides an efficient, user-friendly way for suppliers and purchasers to determine a most desired manufacturing or supply plan based on an optimal number of periodic setups, an optimal order quantity, and an optimal should-cost purchase price for assembled goods. In one embodiment, computer program tool 700 may be used as a supplement to the negotiation process discussed above in connection with FIG. 6. That is, a supplier and/or purchaser may use computer program tool 700 to determine optimal values to populate a data file used for negotiating a purchase price for assembled goods. In one embodiment, both the supplier and the purchaser estimate their own desired should-cost purchase price, number of setups per year, and order quantity using computer program tool 700 and spreadsheets 300 and 400 (e.g., in a manner such as described above in connection with steps 602-606 of FIG. 6), and then the two parties use the results to negotiate a purchase price, number of setups per year, order quantity, and/or other terms (e.g., in manner such as described above in connection with steps 608 and 610 of FIG. 6).

### INDUSTRIAL APPLICABILITY

The disclosed should-cost negotiation methods may be used to negotiate prices between selling and purchasing parties for any type of assembled good. For example, in one embodiment, the should-cost negotiation process disclosed herein may be used by sellers and purchasers of machine equipment for vehicles used in construction, mining, paving, and other similar industries. In one embodiment, the vehicles include dozers, loaders, dump trucks, and other similar machines, and the equipment may include gas tanks, axles, engine parts, vehicle accessory parts, and other parts. However, the should-cost negotiation embodiments described herein may be used in any industry for the sale and purchase of any type of assembled goods.

In one embodiment, the seller is a manufacturer and supplier of the assembled good and the purchaser is a manufacturer that builds machines using one or more assembled goods purchased from one or more suppliers. The seller may be any supplier of the assembled good, such as a re-seller, an original equipment manufacturer (OEM), or any party that sells the assembled good and has access to should-cost information associated with the good. In addition, the seller may be an individual, a company, an agency, or any other entity or organization. The purchaser may be any individual, company, agency, or other entity or organization interested in purchasing assembled goods. In one embodiment, the data used to populate a file is taken from a bill of material stored in connection with the assembled good.

It will be apparent to those skilled in the art that various modifications and variations can be made to the should-cost negotiation embodiments disclosed herein. Other embodiments will be apparent to those skilled in the art from consideration of the specification and practice of the disclosed should-cost negotiation spreadsheet and method. It is intended that the specification and examples be considered as exemplary only, with a true scope being indicated by the following claims and their equivalents.

Further, although the disclosed embodiments include exemplary spreadsheets, it should be noted that any type of file and corresponding data structure may be used to store, process, and display the should-cost information used in the disclosed embodiments. Further, a processor that executes computer program code may be implemented to perform one or more of the should-cost processes disclosed herein. For example, a processor may execute software that performs one or more of the functions programmed in given cells of the disclosed should-cost spreadsheet described herein. Also, the configuration of the spreadsheet and other program tools shown is not limited to those shown or described in FIGS. 3a, 3b, 4a, 4b, 5, 7, and 8.

What is claimed is:

1. A method for negotiating a purchase price for an assembled good to be delivered to a purchaser, the method comprising:
storing a value representing an estimated number of assembled goods desired for delivery in a particular time period;
using a computer program to estimate an optimal number of setups per the time period and an optimal order quantity per setup, based on the value and other stored information, and based on automatic calculations by the computer program;
automatically estimating an optimal should-cost purchase price for the assembled good based on the value, the estimated optimal number of setups, and the estimated optimal order quantity; and
using the estimated optimal should-cost purchase price to negotiate a final purchase price for the assembled good.

2. The method of claim 1, further comprising:
drafting a contract for the purchase of the assembled good, based on the final purchase price.

3. The method of claim 2, further comprising:
delivering or receiving the assembled good according to the terms of the contract.

4. The method of claim 3, wherein the value is provided by a purchaser of the assembled good, and further comprising:
building a machine using the delivered or received assembled good.

5. The method of claim 1, further comprising:
manufacturing the assembled good based on the estimated optimal number of setups and the estimated optimal order quantity per setup.

6. The method of claim 1, further comprising:
automatically obtaining the value from a spreadsheet program by a computer program tool;
receiving one or more user selections using the computer program tool, to calculate additional data values; and
based on the one or more selections, automatically estimating the optimal number of setups per the time period and the optimal order quantity per setup.

7. The method of claim 1, further comprising:
using the computer program by a purchaser to estimate the optimal should-cost purchase price of the assembled good for the purchaser;
sending a copy of the computer program to a supplier;
receiving an estimated optimal should-cost purchase price of the assembled good from the supplier; and
negotiating the final purchase price of the assembled good using the estimated optimal should-cost purchase price for the purchaser and the estimated optimal should-cost purchase price received from the supplier.

8. The method of claim 1, wherein the value is stored by being input into a spreadsheet, and further comprising:
providing additional values into the spreadsheet, the additional values representing at least one of: cost of material to manufacture the assembled good; labor time to manufacture the assembled good; setup time to manufacture the assembled good; and parts used to manufacture the assembled good;
automatically displaying the value and one or more of the additional values in a new file or page in response to a user selection; and
automatically displaying a second value and second additional values in the new file or page, the second value and second additional values associated with a second assembled good, so that a user can view the value and the additional values for the assembled good, and the second value and second additional values for the second assembled good in the new file or page.

9. A method of providing an estimated optimal should-cost purchase price for an assembled good to be delivered to a purchaser, comprising:
storing a value representing an estimated number of assembled goods desired for delivery in a particular time period;
estimating, using a computer program tool that is part of a computer program, and based at least on the value, an optimal number of setups per the particular time period and an optimal order quantity per setup for the assembled good;
automatically inputting data into a data structure that is part of the computer program, the data including the estimated optimal order quantity and the estimated optimal number of setups;
using the computer program to estimate, based on one or more stored equations, an optimal should-cost purchase price for the assembled good; and
providing the estimated optimal should-cost purchase price to a user of the computer program tool.

10. The method of claim 9, further comprising:
using the estimated optimal should-cost purchase price to negotiate a final purchase price for the assembled good; and
drafting a contract for the purchase of the assembled good, based on the final purchase price.

11. The method of claim 10, further comprising:
delivering or receiving the assembled goods according to the terms of the contract.

12. The method of claim 11, wherein the value is provided by a purchaser of the assembled good, and further comprising:
building a machine using the delivered or received assembled good.

13. The method of claim 9, further comprising:
manufacturing the assembled good based on the estimated optimal number of setups and the estimated optimal order quantity per setup.

14. The method of claim 9, further comprising:
using the computer program by a purchaser to estimate the optimal should-cost purchase price of the assembled good for the purchaser;
sending a copy of the computer program to a supplier;
receiving an estimated optimal should-cost purchase price of the assembled good from the supplier; and
negotiating a final purchase price of the assembled good using the estimated optimal should-cost purchase price for the purchaser and the estimated optimal should-cost purchase price received from the supplier.

15. The method of claim 9, further comprising:
using the computer program by a supplier to estimate the optimal should-cost purchase price of the assembled good for the supplier;
receiving an estimated optimal should-cost purchase price of the assembled good from the purchaser; and
negotiating a final purchase price of the assembled good using the estimated optimal should-cost purchase price for the supplier and the estimated optimal should-cost purchase price received from the purchaser.

16. The method of claim 9, herein the value is stored by being input into a spreadsheet, and further comprising:
providing additional values into the spreadsheet, the additional values representing at least one of: cost of material to manufacture the assembled good; labor time to manufacture the assembled good; setup time to manufacture the assembled good; and parts used to manufacture the assembled good;
automatically displaying the value and one or more of the additional values in a new file or page in response to a user selection; and
automatically displaying a second value and second additional values in the new file or page, the second value and second additional values associated with a second assembled good, so that a user can view the value and the additional values for the assembled good, and the second value and second additional values for the second assembled good, in the new file or page.

17. A computer program product stored on a computer-readable medium, the computer program product comprising instructions configured to cause one or more processors to:
receive a value representing a number of assembled goods desired for delivery in a particular time period;
estimate an optimal number of setups per the time period and an optimal order quantity per setup, based on the value and other stored information, and based on automatic calculations;
automatically estimate an optimal should-cost purchase price for the assembled goods based on the value, the estimated optimal number of setups, and the estimated optimal order quantity; and
cause the estimated optimal should-cost purchase price to be displayed on a display screen, to be used to negotiate a final purchase price for the assembled goods.

18. The computer program product of claim 17, wherein the instructions are further configured to cause the one or more processors to:
receive the value using a computer program tool;
receive one or more user selections using the computer program tool, to calculate additional data values; and
based on the one or more selections, automatically estimate the optimal number of setups per the time period and the optimal order quantity per setup.

19. The computer program product of claim 17, wherein the instructions are further configured to cause the one or more processors to:
receive the value based on data input into a spreadsheet;
cause additional values to be included into the spreadsheet, the additional values including at least one of: cost of material to manufacture the assembled goods; labor time to manufacture the assembled goods; setup time to manufacture the assembled goods; and parts used to manufacture the assembled goods;
cause the value and one or more of the other values to be displayed in a new file or page in response to a user selection; and
cause a second value and second additional values to be displayed in the new file or page, the second value and second additional values associated with a second assembled good, so that a user can view the value and the additional values for the assembled good, and the second value and second additional values for the second assembled good, in the new file or page.

20. The computer program product of claim 17, wherein the instructions are further configured to cause the one or more processors to:
estimate the optimal number of setups per the time period and the optimal order quantity per setup based on stored formulas and based on at least: a cost of material required to manufacture the assembled goods; labor time required to manufacture the assembled goods; setup time required to manufacture the assembled goods; and parts used to manufacture the assembled goods.
